(19) United States
(12) Patent Application Publication
(10) Pub. No.: US 2007/0146880 A1
(43) Pub. Date: Jun. 28, 2007

(54) Optical device for splitting an incident light into simultaneously spectrally separated and orthogonally polarized light beams having complementary primary color bands

(75) Inventors: William P. Bleha, Carlsbad, CA (US); Rodney D. Sterling, Carlsbad, CA (US)

Correspondence Address: Michael J. Berger, Esq.;Amster, Rothstein & Ebenstein LLP, 90 Park Avenue, New York, NY, 10016, US

(73) Assignee: JVC Americas Corporation

(21) Appl. No.: 11/319,833

(22) Filed: Dec. 27, 2005

(51) Int. Cl. G02B 27/22

(52) U.S. Cl. 359/468; 359/465; 359/498

(57) ABSTRACT

The present invention relates to an optical device for splitting incident unpolarized white light into simultaneously spectrally separated and orthogonally polarized light beams having complementary primary color bands by using interference filters for primary color bands such as the Infitec filters. The optical device embodying the present invention can be used in, for example, illumination systems for passive stereoscopic 3D display systems. When used in the stereoscopic 3D display system, the present invention provides a high degree of spectral and polarization separation of the individual stereoscopic images and the increased efficiency in use of illumination light compared to the conventional stereoscopic projection systems.

### FIELD OF THE INVENTION

The present invention generally relates to manipulation of the polarization and spectral states of a light beam in an optical system. More particularly, the present invention relates to an optical device for splitting incident light into simultaneously spectrally separated and orthogonally polarized light beams having complementary primary color bands (i.e., red, green and blue, or yellow, cyan and magenta wavelength triplet bands). The present invention may be used in an optical display system such as stereoscopic three-dimensional (3D) projection display systems.

### BACKGROUND OF THE INVENTION

Because of the physical separation between the left eye and the right eye of a viewer and the consequent difference in the corresponding perspectives of the two eyes, an artificial perception of 3D depth can be created by displaying two slightly different images for the left eye and the right eye of the viewer, respectively. One way to accomplish this is to project two images containing slightly different image information onto the screen and to enable the left eye of the viewer to view only its corresponding image (“the left-eye image”) and the right eye of the viewer to view only its own corresponding image (“the right-eye image”) which is slightly different from the left-eye image. This is also known as the stereoscopic separation of images.

Typical ways to differentiate between the left-eye and the right-eye images are based on the light polarization and the color-spectral separation. For example, the light beams for the left-eye and the right-eye images may be respectively polarized in directions orthogonal to each other. A viewer is provided with a pair of special eyeglasses with two matching orthogonal polarization filters. The left-eye filter transmits only the light beam polarized in the polarization direction of the left-eye image and, likewise, the right-eye filter transmits only the light beam polarized in the polarization direction of the right-eye image. Thereby, the viewer wearing this special polarized eyeglasses is able to view a stereoscopic 3D image.

A polarizing beam splitter (PBS) is typically used to split the light into two orthogonally polarized light beams. Two orthogonally polarized light beams may be two light beams in linear polarization states that are perpendicular to each other, or two circularly polarized light beams, one being in the state of right-hand circular polarization and the other being in the state of left-hand circular polarization. The most well-known conventional PBS is a PBS of the MacNeille type (“the MacNeille PBS”) (also known as the Brewster angle polarizing beam splitter), which is described in detail in H. A. MACLEOD, THIN-FILM OPTICAL FILTERS 328-32 (2d ed. 1986). One example of a PBS of the MacNeille type is schematically illustrated in FIG. 1. The MacNeille PBS 100 in FIG. 1 may comprise two glass prisms 104 and 106joined at an interface comprising a multilayer stack 105 of two or more materials. For example, the PBS shown in FIG. 8.10 of Macleod cited above uses two multilayers of zinc sulphide (ZnS) and Cryolite joined by cement.

The interface of the MacNeille PBS is designed to satisfy the Brewster condition so that at an appropriate angle of incidence, the reflected and transmitted light beams are completely polarized in orthogonal directions. In FIG. 1, unpolarized light 101 is incident on the upper-left surface of the PBS 100 at a right angle and after passing through a MacNeille PBS, the light is split into two orthogonally polarized beams: A transmitted light 103 emerges from the lower-right surface of the PBS 100 at a right angle and is polarized parallel to the plane of incidence (also known as “p-polarized” or “p-state”). A reflected light 102 comes out of the upper-right surface of the PBS 200 at a right angle and is polarized perpendicular to the plane of incidence (also known as “s-polarized” or “s-state”).

Another type of PBS of similar construction is a PBS of the 3M reflective type (“the 3M PBS”) described in an article entitled “3M PBS for High Performance LCOS Optical Engine” by Stephen Eckhardt et al. of 3M Optical Systems Division, the contents of which are incorporated herein by reference in their entirety. The 3M PBS is based on a plastic film made of multiple layers of highly birefringent polymers and is formed by having the plastic film laminated between glass prisms. In producing a linear polarization state over a wide range of angles and wavelengths, the performance of the 3M PBS is superior to that of the conventional MacNeille PBS.

Yet another type of PBS of similar construction is a prism cube beamsplitter, which is made by joining together two precision right angle prisms with the appropriate interference coating on the hypotenuse surface. Other types of PBS include a broadband cube beamsplitter and a laser-line cube beamsplitter which operate on different wavelengths with different operating ranges. Like the PBS of the MacNeille type, these polarizing cube beamsplitters separate unpolarized light into two orthogonally polarized light beams at 90°.

Another approach for achieving stereoscopic separation between the left-eye and the right-eye images is to have the their respective color spectra separated slightly, but non-overlappingly, by a special kind of spectral filter, such as interference filter.

An interference filter is an optical filter that transmits one or more selected spectral bands or lines and reflects others. It typically maintains a nearly zero coefficient of absorption for all light wavelengths of interest. An interference filter may be formed from multiple thin layers of dielectric material having different refractive indices on, for example, a glass substrate. The interference effects between the incident and reflected light waves at the thin-film boundaries provide interference filters with wavelength-selective characteristics.

With a pair of special eyeglasses having matching spectral filters, a viewer is able to view a stereoscopic 3D image by having different eyes respectively perceiving images with slightly offset color spectra.

One of more sophisticated approaches is based on stereoscopic separation of images having non-overlapping, complementary primary color bands. This is used by the Infitec™ (Interference Filter Technique) stereo display system described in “Infitec—A New Stereoscopic Visualisation Tool By Wavelength Multiplex Imaging” by Helmut Jorke and Markus Fritz, the contents of which are hereby incorporated by reference in their entirety. Light entering human eyes is separated into three spectral ranges or bands by three types of receptors respectively corresponding to three primary colors: red (R), green (G) and blue (B). Based on this principle, the Infitec system uses wavelength multiplex visualization to generate stereoscopic 3D images. More specifically, by using highly selective interference filters (“the Infitec filters”) capable of transmitting one set of primary color bands or lines at selected red, green and blue wavelengths and reflecting the complementary set of primary color bands or lines (“the Infitec-type spectral separation”), it generates two sets of non-overlapping RGB spectral triplets for the left-eye image and the right-eye image, respectively: (R₁, G₁, B₁) representing the primary color bands or lines at selected red, green and blue wavelengths for the left-eye image and (R₂, G₂, B₂) representing the complementary primary color bands or lines at different red, green and blue wavelengths for the right-eye image. The spectra of (R₁, G₁, B₁) and (R₂, G₂, B₂) are non-overlappingly separated from each other.

FIGS. 2a-2c show an example of a continuous spectrum F of an incident light in the visible light spectrum (FIG. 2a) separated into two sets of non-overlapping primary color bands or RGB spectral triplets (R₁, G₁, B₁) (FIG. 2b) and (R₂, G₂, B₂) (FIG. 2c), respectively for the left-eye and for the right-eye images, by the Infitec filter for wavelength multiplex visualization. Those two RGB spectral triplets may be close enough to be within the bandwidth of the human eye receptor for the respective primary colors, but still non-overlapping. Typically, the Infitec system requires two light sources and their corresponding Infitec filters to generate two sets of RGB spectral triplets (R₁, G₁, B₁) and (R₂, G₂, B₂).

The 3D imaging system based on the stereoscopic projection of the slightly different left-eye and right-eye images generated by the above-described methods and others and the special eyeglasses with the matching filters for the viewer is known as the passive stereoscopic 3D display system. The passive stereoscopic 3D display system may have just one projector to project both the left-eye images and the right-eye images alternately at double refresh rate. Alternatively, the display system may have two projectors to display the left-eye images and the right-eye images, respectively, at standard refresh rate.

While various projector technologies can be and have been used in the passive stereoscopic 3D display systems, including LCOS (Liquid Crystal On Silicon), LCD (Liquid Crystal Display), CRT (Cathode-Ray Tube), DLP™ (Digital Light Processing) projectors, the preferable projector technology for the passive stereoscopic 3D display systems is the D-ILA™ (Digital Drive Image Light Amplifier) developed by Victor Company of Japan, Ltd. (JVC). D-ILA™ is JVC's proprietary reflective mode active matrix liquid crystal display commonly referred to as LCOS in the industry. The D-ILA™ projector technology is described in detail in “D-ILA Projector Technology: The Path to High Resolution Projection Displays” by W. P. Bleha and International Publication No. WO 02/17547 A2 entitled VERY-LARGE-SCALE VERY-HIGH-RESOLUTION MULTIPLE-PROJECTOR TILED DISPLAY WITH UNIFORM INTENSITY, COLOR TEMPERATURE AND COLOR BALANCE THROUGHOUT BY USE OF A SINGLE LIGHT SOURCE FOR EACH COLOR; INTENSITY AND SPECTRAL MANAGEMENT IN ALL LIGHT PATHS; AND OPTIONAL FRESNEL LENSES BEHIND EACH DISPLAY TILE, the contents of both of which are incorporated herein by reference in their entirety.

LCOS and LCD projectors require polarized light for their operation. For pairs of projectors used for passive 3D stereographic applications using Infitec-type filters, it would be advantageous to provide each projector with a polarized, spectrally split light beam generated from a common light source.

FIG. 3 schematically illustrates an example of the conventional stereoscopic 3D display system 300 using two complementary Infitec filters 305, 306 and the conventional PBSs 309, 310 to generate spectrally separated and orthogonally polarized light beams 312, 313 for the left-eye and the right-eye images, respectively. Unpolarized, white light beams 303 and 304 from the two corresponding light sources 301 and 302 pass through the Infitec filters 305 and 306 and the transmitted light beams are two spectrally separated light beams (R₁, G₁, B₁) 307 and (R₂, G₂, B₂) 308. In this spectral separation process, the light beams reflected from the filters 305 and 306 are not used and therefore wasted. Each of these spectrally separated light beams 307 and 308 then passes through a PBS 309, 310 to be split into two orthogonally polarized light beams at s state 311, 313 and p state 312, 314. The p-polarized (R₁, G₁, B₁) light beam 312 is selected to be used for the left-eye image and sent to, for example, a projector 315 for the left-eye image and the s-polarized (R₂, G₂, B₂) light beam 313 is selected to be used for the right-eye image and sent to, for example, a projector 316 for the right-eye image projector. On the other hand, the s-polarized (R₁, G₁, B₁) light beam 311 and the p-polarized (R₂, G₂, B₂) light beam 314 are not needed for the passive stereoscopic 3D projection and therefore discarded. Accordingly, more than 50% of the original illumination light from the light source is wasted and cannot be utilized in the final display. The source of this inefficiency lies in the sequential process of spectral separation and then polarizing beam splitting which result in generating the light beams having the spectral and polarization states that are not needed for the stereoscopic projection.

This source of inefficiency in the conventional stereoscopic 3D display system using two projectors can be eliminated if the sequential process of spectral separation and polarizing beam splitting is replaced by simultaneous spectral separation and orthogonal polarization of a single input light beam so that all of the output of the spectral separation and polarizing beam splitting process can be utilized in the two projectors for stereoscopic 3D projection. The concept of simultaneous color splitting and polarization beam splitting in the context of color management was shown in an article “LCoS Projection Color Management Using Retarder Stack Technology” by Gary Sharp et al., 23 DISPLAYS 121, 122 (2002) (“the Sharp Article”). See also U.S. Pat. No. 5,751,384 to Sharp entitled “Color Polarizers for Polarizing an Additive Color Spectrum Along a First Axis and It's Compliment Along a Second Axis” (“the '384 Patent”), and U.S. Pat. No. 6,816,309 to Jianmin Chen et al. entitled “Compensated Color Management Systems and Methods” (“the '309 Patent”). FIG. 2 of the Sharp Article illustrates an optical arrangement comprising a ColorSelect™ filter and a conventional PBS. The ColorSelect™ filter is made of multilayer polycarbonate retardation films and is capable of converting one spectral band to the orthogonal polarization while leaving the state of polarization of the complementary portion of the light spectrum unchanged. In other words, the selected color band of an incident light passing through a ColorSelect™ filter acquires the state of polarization orthogonal to the polarization direction of the remaining complementary color spectrum of the light. These two orthogonally polarized color-split components can then be physically separated in accordance with their respective polarization states by applying a conventional PBS. In this way, the Sharp Article, as well as the '384 Patent and the '309 Patent, shows how a combination of a ColorSelect™ filter and a conventional PBS can become simultaneously color splitter and polarizing beam splitter.

However, in some cases, a combination of ColorSelect™ filter and a conventional PBS may not be preferred or desirable in an optical system. For example, the ColorSelect™ filter does not have the high degree of wavelength specificity of the Infitec filter and therefore additionally requires one or more special clean up polarizers such as wire-grid polarizer or 3M PBS to achieve the similar level of the wavelength specificity. These shortcomings severely limit the potential applicability of the ColorSelect™ filter to the stereoscopic 3D projection based on spectral separation and orthogonal polarization. Accordingly, there exists a need for a different optical device for splitting an incident light into simultaneously spectrally separated and orthogonally polarized light beams having complementary primary color bands (R₁, G₁, B₁) and (R₂, G₂, B₂). The present invention addresses this need.

The present invention seeks to overcome the shortcomings of the conventional passive stereoscopic 3D display LCD and LCOS systems that use spectral separation to differentiate between the left-eye and the right-eye images.

In particular, the present invention seeks to overcome the shortcomings that are present in the conventional passive stereoscopic 3D display systems based on the Infitec filters and PBSs.

More specifically, the present invention seeks to make the passive stereoscopic 3D display systems more efficient in use of the illumination light by splitting an incident light into simultaneously spectrally separated and orthogonally polarized light beams having complementary primary color bands (R₁, G₁, B₁) and (R₂, G₂, B₂).

It is another object of the present invention to reduce the waste of illumination light for the projectors during the process of spectral separation and polarizing beam splitting to theoretically zero by providing an optical filter capable of achieving simultaneous spectral separating-polarizing beam splitting into orthogonally polarized light beams having complementary primary color bands.

It is yet another object of the present invention to turn unpolarized white light into spectrally non-overlapping RGB triplets (R₁, G₁, B₁) and (R₂, G₂, B₂) that are simultaneously orthogonally polarized.

It is yet another object of the present invention to generate spectrally separated and orthogonally polarized light beams having complementary primary color bands from a single light source.

It is yet another object of the present invention to split an incident unpolarized white light into simultaneously spectrally separated and orthogonally polarized light beams having complementary primary color bands by using one or more Infitec filters or the like.

Other objects and advantages of the present invention will become apparent from the following description.

### SUMMARY OF THE INVENTION

It has now been found that the above and related objects of the present invention are obtained in the form of several related aspects, including a simultaneous spectral filtering and polarizing beam splitting device.

More particularly, the present invention relates to an optical device for splitting an incident light into simultaneously spectrally separated and orthogonally polarized light beams having complementary primary color bands, comprising one or more optical elements which (1) receive incident light as an input, (2) separate the incident light into a first polarized state and a second orthogonally polarized state, (3) separate the spectrum of the incident light into first primary color bands and second complementary and non-overlapping primary color bands, and (4) produce as a sole output a first output light beam having the first polarized state and the first primary color bands and a second output light beam having the second polarized state and the second primary color bands.

The present invention is also directed to a stereoscopic display system comprising a source of an incident light, one or more optical elements which (1) receive the incident light as an input, (2) separate the incident light into a first polarized state and a second orthogonally polarized state, (3) separate the spectrum of the incident light into first primary color bands and second complementary and non-overlapping primary color bands, and (4) produce as a sole output a first output light beam having the first polarized state and the first primary color bands and a second output light beam having the second polarized state and the second primary color bands, and one or more display projectors for using the first and the second output light beams for stereoscopic image display.

Furthermore, the present invention also relates to a method of displaying images, comprising the steps of receiving incident light from a light source, and processing the incident light to generate, as a sole output, a first output light beam having a first polarized state and first primary color bands and a second output light beam having a second orthogonally polarized state and second complementary and non-overlapping primary color bands.

### BRIEF DESCRIPTION OF THE DRAWINGS

The above and related objects, features and advantages of the present invention will be more fully understood by reference to the following, detailed description of the preferred, albeit illustrative, embodiment of the present invention when taken in conjunction with the accompanying figures, wherein:

FIG. 1 shows an example of the prior art PBS of the MacNeille type.

FIG. 2, consisting of FIGS. 2a-2c, illustrates two non-overlapping spectral RGB triplets (R₁, G₁, B₁) and (R₂, G₂, B₂) generated from the continuous visible light spectrum F by the Infitec filters.

FIG. 3 is an optical schematic diagram of an example of the conventional passive stereoscopic 3D display system using two light sources, Infitec-type filters and PBSs.

FIG. 4 is an optical schematic diagram of an example of the passive stereoscopic 3D display system embodying the present invention.

FIG. 5A illustrates an alternative embodiment of the present invention.

FIG. 5B illustrates a variation of the FIG. 5A embodiment, operating on the same principle.

FIG. 6A illustrates a three-dimensional configuration of an example of practical implementation of the present invention in the passive stereoscopic projection system using a LCOS projector. FIG. 6B is an optical path schematic for FIG. 6A.

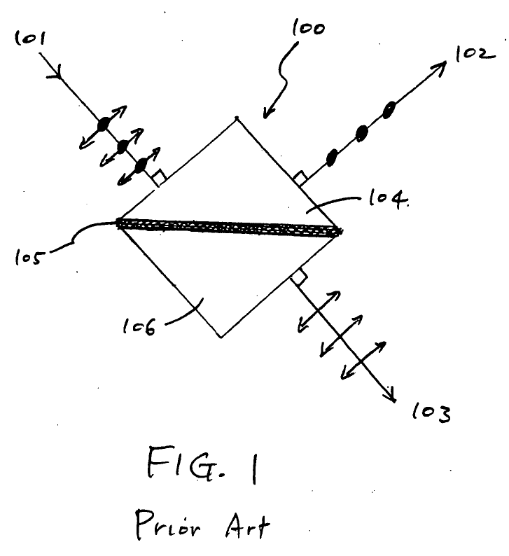

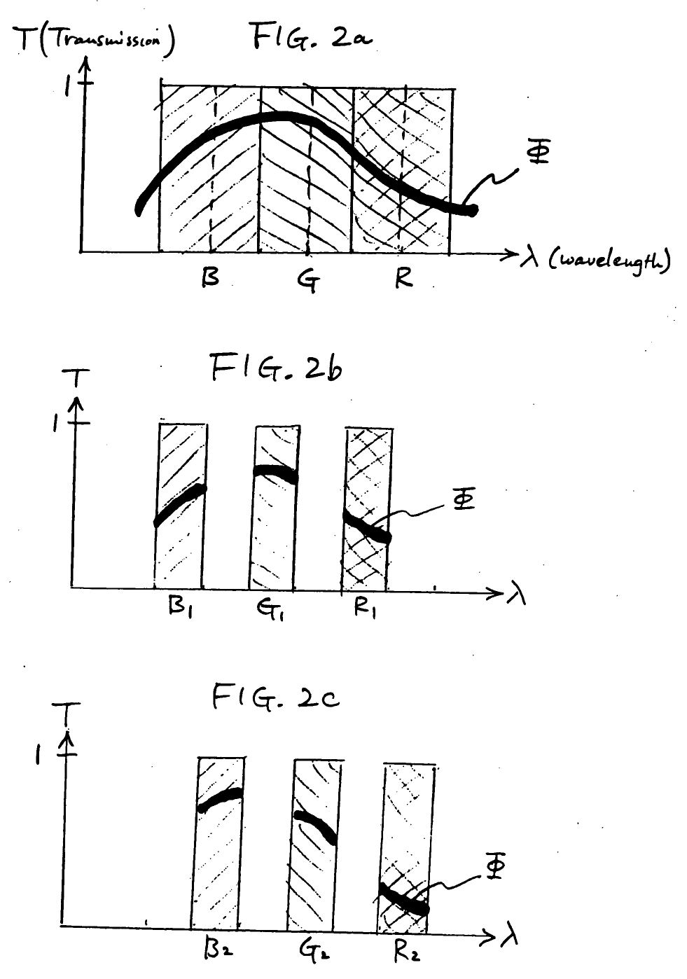

### DETAILED DESCRIPTION OF THE PREFERRED EMBODIMENTS

The present invention seeks to overcome the inefficiency of the conventional stereoscopic 3D display system using both the Infitec-type spectral separation and polarizing beam splitting by providing an optical device or optical filter capable of splitting an incident unpolarized white light into simultaneously spectrally separated and orthogonally polarized light beams having complementary primary color bands (R₁, G₁, B₁) and (R₂, G₂, B₂).

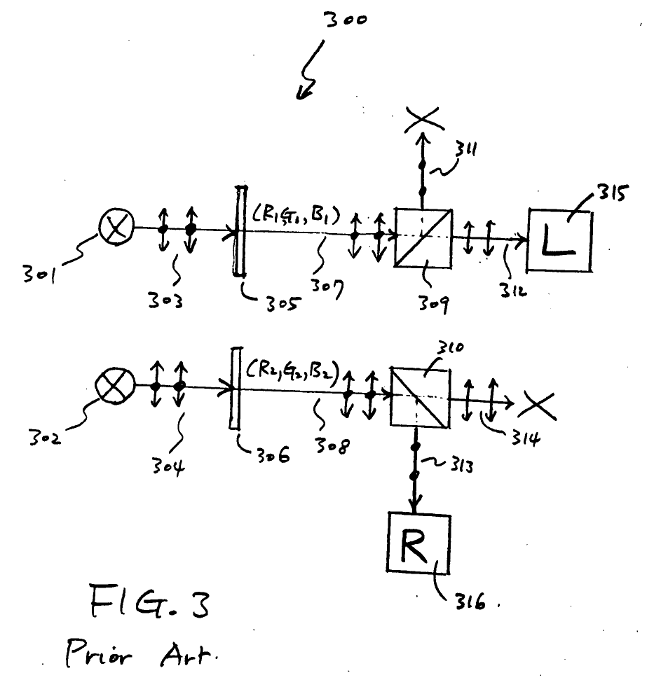

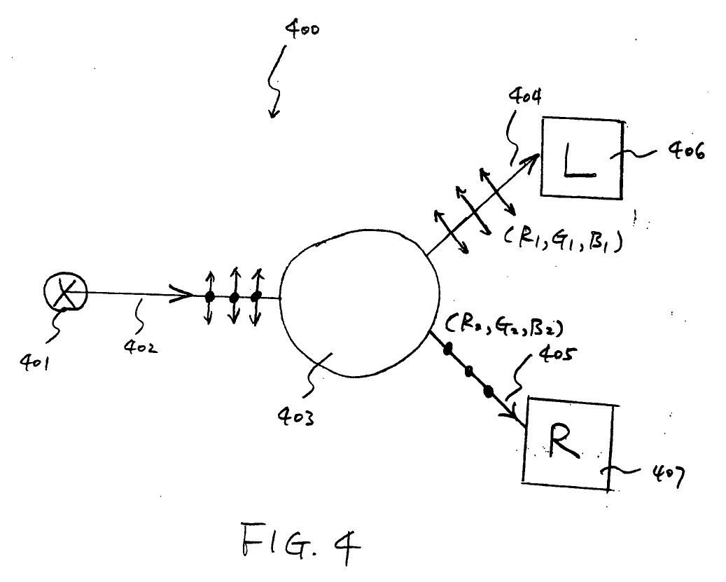

The advantage of the present invention over prior art is apparent in FIG. 4, which illustrates the general concept of the passive stereoscopic 3D projection system embodying the present invention. In FIG. 4, unpolarized white light 402 from a single light source 401 is incident on an optical device 403 embodying the present invention. The optical device 403 is designed to split the incident light 402 into simultaneously spectrally separated and orthogonally polarized light beams 404 and 405 having complementary primary color bands (R₁, G₁, B₁) and (R₂, G₂, B₂), respectively. In this particular example, the output of the device 403 are the p-polarized (R₁, G₁, B₁) light beam for a projector 406 for the left-eye image and the s-polarized (R₂, G₂, B₂) light beam for a projector 407 for the right-eye image. Unlike the prior art projection system shown in FIG. 3, since all of the outputs 404 and 405 of the device 403 are directly utilized by the stereoscopic projection system, the waste of the illumination lights originated from the light source 401 can be minimized. Furthermore, the display system embodying the present invention can use only a single light source to generate simultaneously spectrally separated and orthogonally polarized light beams for both the left-eye and the right-eye images.

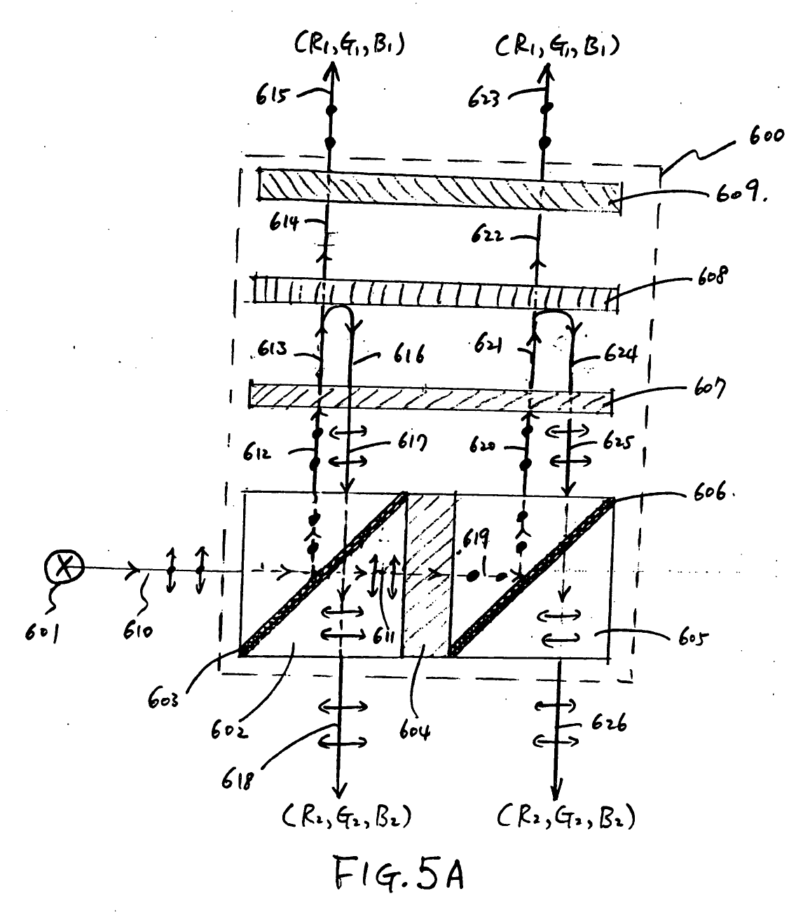

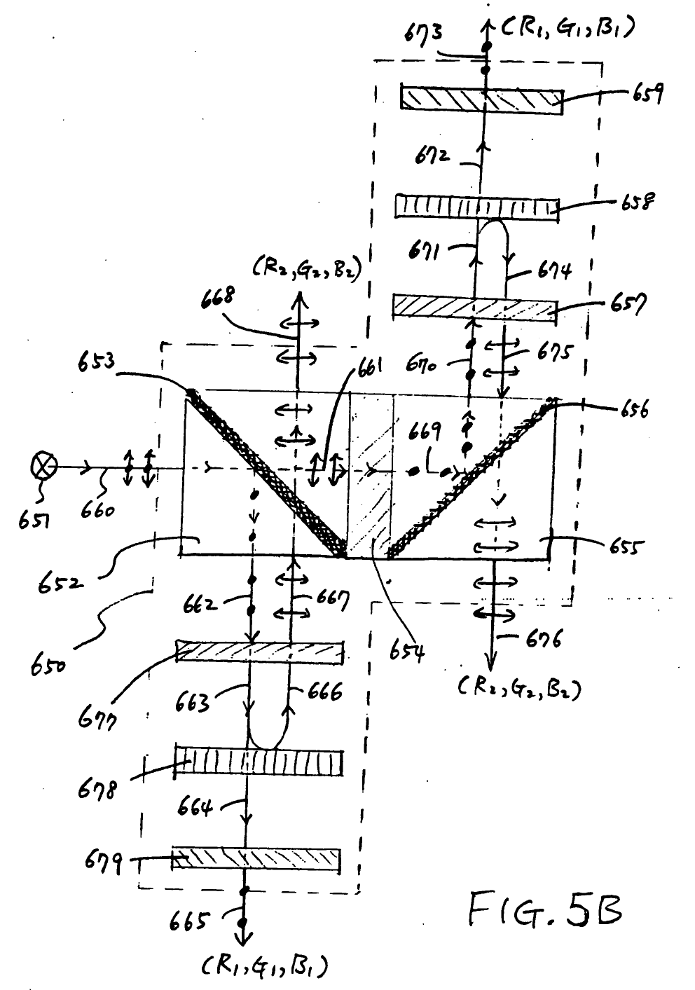

The present invention may be implemented in various ways and forms. FIG. 5A illustrates one embodiment of the present invention utilizing the Infitec filters or the like. The optical device 600 embodying the present invention in FIG. 5A comprises two conventional broadband PBSs 602 and 605 separated by a broadband half-wave plate 604. The device 600 is designed so that the light beams 612 and 620 reflected from the respective interfaces 603 and 606 of the corresponding PBSs 602 and 605 are directed toward a broadband quarter-wave plate 607, an Infitec filter or the like 608 for transmitting light having selected primary color bands (R₁, G₁, B₁) and reflecting light having complementary primary color bands (R₂, G₂, B₂), and another broadband quarter-wave plate 609 for undoing the phase-shift caused by the first quarter-wave plate 607.

Unpolarized white light 610 from a single light source 601 is split at the interface 603 of the first PBS 602 into a p-polarized transmitted beam 611 and a s-polarized reflected beam 612. The polarization axes of the half-wave plate 604 are positioned in such a way that the polarization state of the transmitted beam 611 is converted from p-state to estate 619 by passing through the half-wave plate 604. Since the light incident on the interface 606 of the second PBS 605 is purely s-state, it is completely reflected in its entirety at the interface 606 and the second PBS 605 outputs only a reflected beam 620 in s-state. Both of the reflected beams 612 and 620 in s-state of polarization are designed to pass through the first quarter-wave plate 607. The polarization axes of the first quarter-wave plate are positioned in such a way that the s-polarized beams 612 and 620 become circularly polarized light 613 and 621 after passing through the quarter-wave plate 607.

The Infitec filter or the like 608 transmits Infitec-type spectrally separated light beams 614 and 622 having selected primary color bands (R₁, G₁, B₁) and reflects light beams 616 and 624 having the complementary primary color bands (R₂, G₂, B₂) back toward the first quarter-wave plate 607. The reflected beams 616 and 624 a5Ain pass through the first quarter-wave plate 607, which converts the polarization state of the beams from the circular polarization 616, 624 to p-state 617, 625. The p-polarized beams 617 and 625 then pass through the PBSs 602 and 605, respectively, and emerge on the bottom of FIG. 5A as p-polarized light beams 618 and 626 in spectral state of primary color bands (R₂, G₂, B₂) as output of the device 600. These two beams 618 and 626 in the same polarization and spectral state are combined without any loss into a single beam by a beam combiner or other appropriate optical means.

Meanwhile, the circularly polarized beams 614 and 622 at spectral state of primary color bands (R₁, G₁, B₁) pass through the second quarter-wave plate 609. The polarization axes of the second quarter-wave plate 609 are positioned in such a way as to undo the phase shift caused by the first quarter-wave plate 607 and convert the polarization state of the beams from the circular polarization 614, 622 back to s-state 615, 623. Accordingly, the s-polarized beams 615 and 623 in spectral state of primary color bands (R₁, G₁, B₁) emerge on the top of FIG. 5A as another output of the device 600. These two beams 615 and 623 in the same polarization and spectral state are combined without any loss into a single beam by a beam combiner or other appropriate optical means. In this way, the optical device 600 embodying the present invention in FIG. 5A splits the incident unpolarized white light into simultaneously spectrally separated and orthogonally polarized light beams having complementary primary color bands.

FIG. 5B shows an alternative variation of the FIG. 5A embodiment that operates on the same principle. Instead of outputting two s-polarized beams 615 and 623 having primary color bands (R₁, G₁, B₁) on the top of the figure and two p-polarized beams 618 and 626 having the complementary primary color bands (R₂, G₂, B₂) on the bottom of the figure as in FIG. 5A, the FIG. 5B embodiment generates one s-polarized beam having primary color bands (R₁, G₁, B₁) and one p-polarized beam having the complementary primary color bands (R₂, G₂, B₂) on both the top and the bottom of the figure. These two pairs of spectrally separated and orthogonally polarized outputs can be used by two pairs of projectors for the stereoscopic 3D projection displays.

The optical device 650 embodying the present invention in FIG. 5B comprises two conventional broadband PBSs 652 and 655 separated by a broadband half-wave plate 654. The device 650 is designed in such a way that the light beam 662 reflected from the interface 653 of the corresponding PBS 652 is directed toward a broadband quarter-wave plate 677, an Infitec filter or the like 678 for transmitting light having selected primary color bands (R₁, G₁, B₁) and reflecting light having the complementary primary color bands (R₂, G₂, B₂), and another broadband quarter-wave plate 679 for undoing the phase-shift caused by the quarter-wave plate 677. Likewise, the beam 670 reflected from the interface 656 of the corresponding PBS 655 is designed to be directed toward a broadband quarter-wave plate 657, an Infitec filter or the like 658 for transmitting light having the primary color bands (R₁, G₁, B₁) and reflecting light having the complementary primary color bands (R₂, G₂, B₁), and another broadband quarter-wave plate 659 for undoing the phase-shift caused by the quarter-wave plate 657.

In FIG. 5B, unpolarized white light 660 from a single light source 651 is split at the interface 653 of the first PBS 652 into a p-polarized transmitted beam 661 and a s-polarized reflected beam 662. The polarization axes of the half-wave plate 654 are positioned in such a way that the polarization state of the transmitted beam 661 is converted from p-state to estate 669 after passage through the half-wave plate 654. Since the light incident on the interface 656 of the second PBS 655 is purely s-state, it is completely reflected in its entirety at the interface 656 and the second PBS 655 outputs only a reflected beam 670 in s-state. The reflected s-polarized beams 662 and 670 are designed to pass through the first and second quarter-wave plates 677 and 657, respectively. The polarization axes of the first and second quarter-wave plates 677 and 657 are positioned in such a way that the s-polarized beams 662 and 670 become circularly polarized light 663 and 671 after passing through the first and second quarter-wave plates 677 and 657, respectively.

The first and second Infitec filters or the likes 678 and 658 transmit, respectively, spectrally separated light beams 664 and 672 having selected primary color bands (R₁, G₁, B₁) and reflect, respectively, light beams 666 and 674 having the complementary primary color bands (R₂, G₂, B₂). The reflected beams 666 and 674 a5Ain respectively pass through the first and second quarter-wave plates 677 and 657. The first and second quarter wave plates 677 and 657 respectively convert the polarization state of the beams from the circular polarization 666 and 674 to p-state 667 and 675. The p-polarized beams 667 and 675 then respectively pass through the first and second PBSs 652 and 655 and emerge as output of the optical device 650: a p-polarized light beam 668 having primary color bands (R₂, G₂, B₂) directed toward the top of the figure and a beam 676 having the identical spectral and polarization state as the beam 668 directed toward the bottom of the figure. In this configuration, each of the beams 668 and 676 can be used by a projector from each of two pairs of the stereoscopic 3D projectors.

Meanwhile, the circularly polarized beams 664 and 672 having the complementary primary color bands (R₁, G₁, B₁) respectively pass through the third and fourth quarter-wave plates 679 and 659. The polarization axes of the third and fourth quarter-wave plates 679 and 659 are positioned in such a way as to undo the phase shifts caused by the first and second quarter-wave plates 677 and 657 and convert the polarization state of the beams from the circular polarization 664, 672 back to estate 665, 673. Accordingly, the s-polarized beams 665 and 673 having the complementary primary color bands (R₁, G₁, B₁) emerge as another output of the optical device 650, one beam 673 directed toward the top of the figure and another beam 665 directed toward the bottom of the figure. In this configuration, each of the beams 665 and 673 can be used by the remaining projector from each of two pairs of the stereoscopic 3D projectors. In this way, as in FIG. 5A, the optical device 650 embodying the present invention in FIG. 5B splits the incident unpolarized white light into simultaneously spectrally separated and orthogonally polarized light beams having complementary primary color bands.

All of the outputs generated by the optical devices 600 and 650 shown in FIGS. 5A and 5B, respectively, are simultaneously spectrally separated and orthogonally polarized light beams having complementary primary color bands and can be directly used by the stereoscopic 3D display system. Consequently, the waste of the illumination light is minimized. Accordingly, it is shown that the present invention embodied in FIGS. 5A and 5B presents a more efficient way to provide spectrally separated and orthogonally polarized light beams having complementary primary color bands for a passive stereoscopic 3D display system than the conventional system described earlier could.

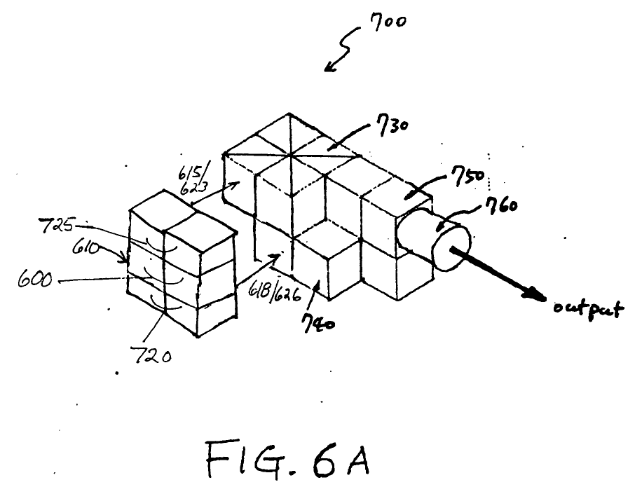

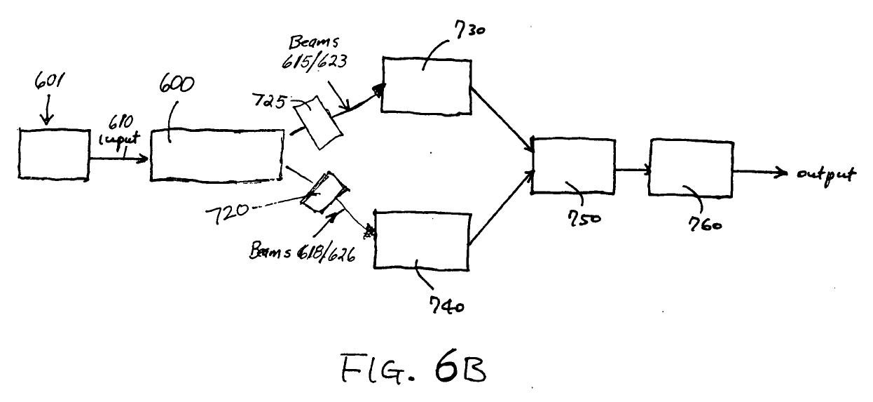

The optical device of the present invention can be incorporated into the existing stereoscopic 3D display technologies, such as dual polarization modulation passive stereo 3D display technologies, based on D-ILA™ , other LCOS, or LCD projection technology, to further improve and enhance their display quality and to increase the efficiency in the use of illumination light. FIG. 6A illustrates a three-dimensional configuration of a potential application of the present invention in the passive stereoscopic projection system 700 based on a D-ILA™ projector with two ColorQuad™ management systems 730 and 740. FIG. 6B is an optical path schematic for FIG. 6A, showing the optical path of light as it is input from a light source 601 into embodiment 600 shown in FIG. 5A, processed by the optical system 700, and output from a projection lens 760 to be projected for stereoscopic display. In FIGS. 6A and 6B, an input light from a light source 601, such as an arc lamp or light fiber, passes through element 600 containing an optical device embodying the present invention. As described above, the optical device generates the output of simultaneously spectrally separated and orthogonally polarized light beams respectively having complementary primary color bands (R₁, G₁, B₁) and (R₁, G₂, B₂), 615/623 and 618/626. These spectrally separated and orthogonally polarized output beams then respectively pass through polarized-beam 90-degree direction turners and combiners 725 and 720 and are directed to, respectively, a ColorQuad™-L 730 for further processing to form a left-eye image and a ColorQuad™-R 740 for further processing to form a right-eye image. The ColorQuad™ is a color management system for LCOS projector technology, such as D-ILA™, and is described in the above-cited Sharp Article, the contents of which are incorporated herein by reference in their entirety. The left-eye image and the right-eye image are then combined at an image combiner 750 and projected through a projection lens 760 for stereoscopic 3D display.

Now that the preferred embodiments of the present invention have been shown and described in detail, various modifications and improvements thereon will become readily apparent to those skilled in the art. It is also noted that the applicability of the present invention is not only limited to the passive stereoscopic 3D display systems. The present invention would be applicable to any other optical devices or systems that may require or benefit from simultaneous combination of Infitec-type spectral separation and orthogonal light polarization. Therefore, the present invention may find useful applications in many areas of optical display technology, optical communication, and other related fields.

The present embodiments are therefore to be considered in all respects as illustrative and not restrictive. Accordingly, the spirit and scope of the present invention is to be construed broadly and limited only by the appended claims, and not by the foregoing specification.

What is claimed is:

1. An optical device for splitting an incident light into simultaneously spectrally separated and orthogonally polarized light beams having complementary primary color bands, comprising one or more optical elements which (1) receive incident light as an input, (2) separate said incident light into a first polarized state and a second orthogonally polarized state, (3) separate the spectrum of said incident light into first primary color bands and second complementary and non-overlapping primary color bands, and (4) produce as a sole output a first output light beam having said first polarized state and said first primary color bands and a second output light beam having said second polarized state and said second primary color bands.

2. The optical device of claim 1, wherein said first polarized state is a s-polarized state and said second polarized state is a p-polarized state.

3. The optical device of claim 1, wherein said first polarized state is a right circularly polarized state and said second polarized state is a left circularly polarized state.

4. The optical device of claim 1, wherein said one or more optical elements comprise:
one or more polarizers for generating said first polarized state and said second orthogonally polarized state; and
one or more spectral separators for generating said first primary color bands and said second complementary and non-overlapping primary color bands.

5. The optical device of claim 4, wherein said one or more spectral separators comprise Infitec filters.

6. The optical device of claim 4, wherein said one or more polarizers comprise polarizing beam splitters.

7. The optical device of claim 4, wherein said one or more polarizers comprise a first polarizing beam splitter and a second polarizing beam splitter, and said one or more spectral separators comprise one or more Infitec filters positioned along the direction of beam reflection respectively from said first polarizing beam splitter and said second polarizing beam splitter, wherein said one or more Infitec filters are designed to transmit said first primary color bands and to reflect said second primary color bands.

8. The optical device of claim 7, further comprising one or more first quarter-wave plates respectively positioned between said first and said second polarizing beam splitters and said one or more Infitec filters respectively along said direction of beam reflection from said first and said second polarizing beam splitters.

9. The optical device of claim 8, further comprising one or more second quarter-wave plates positioned to receive transmitted beams from said one or more Infitec filters and designed to undo a phase shift induced by said one or more first quarter-wave plates.

10. The optical device of claim 9, further comprising a half-wave plate positioned between said first polarizing beam splitter and said second polarizing beam splitter.

11. The optical device of claim 10, wherein (1) said first polarizing beam splitter is designed to receive an incident light beam, to transmit a first p-polarized beam toward said half-wave plate and to reflect a first s-polarized beam toward said one or more first quarter-wave plates; (2) said half-wave plate is designed to convert said first p-polarized beam into a second s-polarized beam; (3) said second polarizing beam splitter is designed to reflect said second s-polarized beam toward said one or more first quarter-wave plates; and (4) said one or more first quarter-wave plates are designed to circularly polarize said first and said second s-polarized beams and transmit them respectively toward said one or more Infitec filters.

12. The optical device of claim 11, wherein said one or more second quarter-wave plates are designed to undo said circular polarization generated by said one or more first quarter-wave plates and to transmit said first output light beam comprising a third s-polarized beam and a fourth s-polarized beam, both of which have said first primary color bands.

13. A display system comprising:
a source of incident light;
one or more optical elements which (1) receive said incident light as an input, (2) separate said incident light into a first polarized state and a second orthogonally polarized state, (3) separate the spectrum of said incident light into first primary color bands and second complementary and non-overlapping primary color bands, and (4) produce as a sole output a first output light beam having said first polarized state and said first primary color bands and a second output light beam having said second polarized state and said second primary color bands; and
one or more display projectors for using said first and said second output light beams for stereoscopic image display.

14. The display system of claim 13, wherein said one or more display projectors are designed to project images for the left eye of an viewer based on said first output light beams and images for the right eye of said viewer based on said second output light beams.

15. The display system of claim 14, further comprising viewing glasses for said viewer, wherein a left-eye lens of said glasses is designed to transmit said left-eye images and a right-eye lens of said glasses is designed to transmit said right-eye images.

16. The display system of claim 13, wherein said one or more display projectors are LCOS projectors.

17. The display system of claim 13, wherein said one or more display projectors are D-ILA™ projectors.

18. The display system of claim 13, wherein said one or more display projectors are a single projector designed to alternatingly project both said left-eye images and said right-eye images s at a fast refresh rate.

19. The display system of claim 13, wherein said first polarized state is a s-polarized state and said second polarized state is a p-polarized state.

20. The display system of claim 13, wherein said first polarized state is a right circularly polarized state and said second polarized state is a left circularly polarized state.

21. The display system of claim 13, wherein said one or more optical elements comprise:
one or more polarizers for generating said first polarized state and said second orthogonally polarized state; and
one or more spectral separators for generating said first primary color bands and said second complementary and non-overlapping primary color bands.

22. The display system of claim 21, wherein said one or more spectral separators comprise Infitec filters.

23. The display system of claim 21, wherein said one or more polarizers comprise polarizing beam splitters.

24. The display system of claim 21, wherein said one or more polarizers comprise a first polarizing beam splitter and a second polarizing beam splitter, and said one or more spectral separators comprise one or more Infitec filters positioned along the direction of beam reflection respectively from said first polarizing beam splitter and said second polarizing beam splitter, wherein said one or more Infitec filters are designed to transmit said first primary color bands and to reflect said second primary color bands.

25. The display system of claim 24, further comprising one or more first quarter-wave plates respectively positioned between said first and said second polarizing beam splitters and said one or more Infitec filters respectively along said direction of beam reflection from said first and said second polarizing beam splitters.

26. The display system of claim 25, further comprising one or more second quarter-wave plates positioned to receive transmitted beams from said one or more Infitec filters and designed to undo a phase shift induced by said one or more first quarter-wave plates.

27. The display system of claim 26, further comprising a half-wave plate positioned between said first polarizing beam splitter and said second polarizing beam splitter.

28. The display system of claim 27, wherein (1) said first polarizing beam splitter is designed to receive an incident light beam, to transmit a first p-polarized beam toward said half-wave plate and to reflect a first s-polarized beam toward said one or more first quarter-wave plates; (2) said half-wave plate is designed to convert said first p-polarized beam into a second s-polarized beam; (3) said second polarizing beam splitter is designed to reflect said second s-polarized beam toward said one or more first quarter-wave plates; and (4) said one or more first quarter-wave plates are designed to circularly polarize said first and said second s-polarized beams and transmit them respectively toward said one or more Infitec filters.

29. The display system of claim 28, wherein said one or more second quarter-wave plates are designed to undo said circular polarization generated by said one or more first quarter-wave plates and to transmit said first output light beam comprising a third s-polarized beam and a fourth s-polarized beam having said first primary color bands.

30. A method of displaying images, comprising the steps of:
receiving incident light as an input; and
processing said incident light to generate, as a sole output, a first output light beam having a first polarized state and first primary color bands and a second output light beam having a second orthogonally polarized state and second complementary and non-overlapping primary color bands.

31. The method of claim 30, wherein said processing step comprises the steps of:
separating said incident light into said first polarized state and said second orthogonally polarized state;
separating the spectrum of said incident light into said first primary color bands and said second complementary and non-overlapping primary color bands; and
producing as a sole output said first output light beam having said first polarized state and said first primary color bands and said second output light beam having said second polarized state and said second primary color bands.

32. The method of claim 30, further comprising the steps of
using said first output light beam to form an image for the left eye of a viewer;
using said second output light beam to form an image for the right eye of said viewer; and
projecting said left-eye image and said right-eye image to display a stereoscopic three-dimensional image.

33. The method of claim 30, wherein said processing step comprises the step of subjecting said unpolarized white light to a group of one or more polarizing beam splitters and one or more Infitec filters.

34. The method of claim 30, wherein said processing step comprises the steps of:
splitting said unpolarized white light into a first s-polarized white light beam and a first p-polarized white light beam;
circularly polarizing said first s-polarized white light beam to produce a first circularly polarized white light beam;
spectrally separating and splitting said first circularly polarized white light beam into a first spectrally separated and circularly polarized light beam having first primary color bands and a second spectrally separated and circularly polarized light beam having second primary color bands, wherein said first primary color bands and second primary color bands are complementary to each other;
changing the polarization state of said first spectrally separated and circularly polarized light beam to produce a first spectrally separated and s-polarized light beam having said first primary color bands;
changing the polarization state of said second spectrally separated and circularly polarized light beam to produce a first spectrally separated and p-polarized light beam having second primary color bands;
changing the polarization state of said first p-polarized white light beam to produce a second s-polarized white light beam;
circularly polarizing said second s-polarized white light beam to produce a second circularly polarized white light beam;
spectrally separating and splitting said second circularly polarized white light beam into a third spectrally separated and circularly polarized light beam having said first primary color bands and a fourth spectrally separated and circularly polarized light beam having said second primary color bands;
changing the polarization state of said third spectrally separated and circularly polarized light beam to produce a second spectrally separated and s-polarized light beam having said first primary color bands; and
changing the polarization state of said fourth spectrally separated and circularly polarized light beam to produce a second spectrally separated and p-polarized light beam having said second primary color bands,
wherein said first output light beam comprises said first and said second spectrally separated and s-polarized light beams having said first primary color bands and said second output light beam comprises said first and said second spectrally separated and p-polarized light beams having said second primary color bands.
